(19) United States
(12) Patent Application Publication
(10) Pub. No.: US 2010/0077037 A1
(43) Pub. Date: Mar. 25, 2010

(54) METHOD AND APPARATUS FOR DELIVERING EMAILS TO A RECIPIENT IN THE FASTEST POSSIBLE FASHION

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/443,600

(22) PCT Filed: Oct. 3, 2007
(86) PCT No.: PCT/IN07/00465

§ 371 Date: Mar. 30, 2009

(30) Foreign Application Priority Data
Oct. 3, 2006 (IN) 1621/MUM/2006

(51) Int. Cl. G06F 15/16

(52) U.S. Cl. 709/206; 709/245

(57) ABSTRACT

The present invention relates generally to a method and system for delivering a message from a sender computing system to a recipient computing system and specifically to a method and system for delivering the message directly to the recipient or as close to the recipient's location as possible in order to enhance the recipients experience.

### FIELD OF INVENTION

The present invention relates generally to a method and system for delivering a message from a sender computing system to a recipient computing system and specifically to a method and system for delivering the message directly to the recipient or as close to the recipient's location as possible in order to enhance the recipients experience.

### BACKGROUND OF THE INVENTION

With the growth of the Internet, email has become the most ubiquitous application on the Internet. Generally everyone has an email address such as myname@mycompany.com or from free email service providers such as Hotmail, Yahoo, Rediff. An email comprises of a part before the @ sign which is called the local part of the address, often the username of the recipient, and the part after the @ sign is a domain name. Hence, the local part in the above example would be “myname” while the domain name would be “mycompany.com”.

Traditionally when a sender sends an email, the mail is received by a set of servers that are designated to accept email for the recipients domain name. For instance myname.com may have a large number of servers serving email for all their users in a particular datacenter. Hence, if a sender wishes to send an email from myemail@sender.com to myfriend@recipient.com where the sender is based in India, and the recipient is based in the UAE and the servers that accept emails for “recipient.com” are in the United States, the email is sent through the senders Internet Service Provider to the “recipient.com” mail servers in the United States using a DNS resolution process known in the art and determining the server responsible for handling email for “recipient.com”. The servers of “recipient.com” receive and store the email and when the recipient comes online and logs into his account using a standard email client, the mail client downloads all the email stored on the server. The recipient however does not get instant delivery of the email even though he may be online at the same time the sender sends the message. In fact the recipients email client needs to poll the recipient mail server to determine whether any mail has arrived for the recipient. Secondly, the email downloading process is slow since the recipient is in the UAE and is downloading emails from a server located in the US. The connectivity between the UAE and the US may further hamper the delivery of the email. Hence there is a need to modify the process of email delivery and attempt a delivery directly to the recipient or as close network-wise to the recipient as possible in order to enhance a sender and recipient's email experience.

### BRIEF DESCRIPTION OF THE FIGURES

The accompanying figures, where like reference numerals refer to identical or functionally similar elements throughout the separate views and which together with the detailed description below are incorporated in and faun part of the specification, serve to further illustrate various embodiments and to explain various principles and advantages all in accordance with the present invention. invention.

FIG. 1 illustrates a block diagram of an embodiment of the present

FIG. 2 illustrates a flow diagram of the process followed by the mail recipient proxy (MRP) and the mail sender proxy (MSP) for registration pursuant to an embodiment of the present invention

FIG. 3A and FIG. 3B illustrate a flow diagram of the process of delivering email pursuant to an embodiment of the present invention.

### DETAILED DESCRIPTION OF THE INVENTION

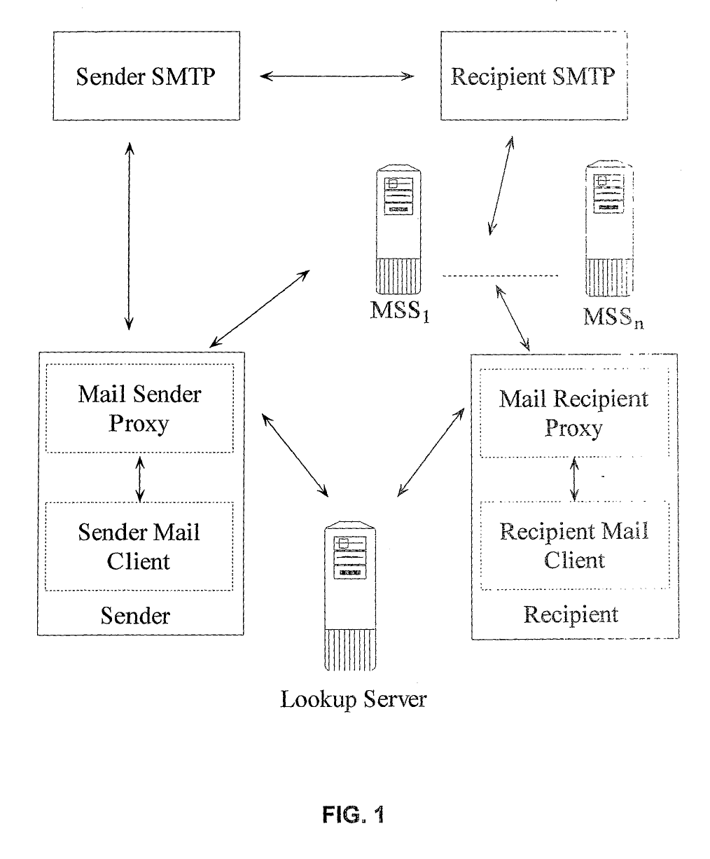

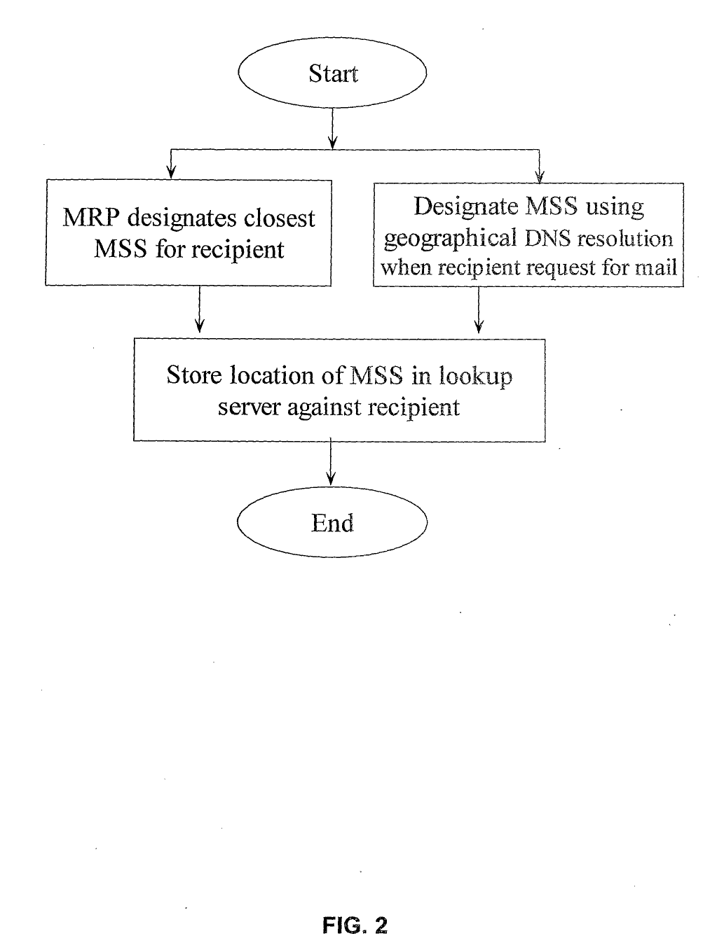

Referring now to FIG. 1 illustrates a block diagram of an embodiment of the present invention. A sender computing system comprises a messaging client using which a user wishes to send a message to a recipient computing system. The messaging client can be a chat client, an email client, an image transfer client or a file transfer protocol client that can be used to communicate with a recipient computing system. Those skilled in the art shall appreciate that although the embodiment described herein illustrates an email messaging service using an email client and the protocols associated therewith, the scope of the present invention shall not be restricted to email messaging. All forms of communication applications on a computing system may be implemented using their appropriate protocols.

Now, consider an embodiment where the sender computing system comprises an email client which is configured to send emails to a recipient computing system. The sender computing system comprises an email client such as Microsoft Outlook, Eudora, Mozilla Thunderbird and the like which is in communication with a mail sender proxy software as described in this invention. The mail sender proxy can be separate software which resides along with the email client of the sender or may also be software that is integrated as a plugin within the email client. Alternatively, the mail sender proxy may also be installed and executed on the Internet Service Providers (ISP) server. Similarly, the recipients computing system comprises an email client to send and receive emails. As per one embodiment, the recipient computing system also comprises a mail recipient proxy that can be a separate software which resides along with the email client of the recipient or may also be software that is integrated as a plugin within the recipient's email client.

Generally, all emails are sent using the Simple Text Transfer Protocol (SMTP). Hence, the senders computing system, uses the sender SMTP server through which the senders computing system can send email. The sender SMTP may be the ISP or a mail service provider of the sender. Similarly, the recipient mail servers receive email from the sender SMTP server and delivers the email to the recipients email client when the recipients email client requests for them. Conventionally, a server running a domain name lookup service is queried to retrieve mail exchange (MX) records for a particular domain name to which the email is being sent. The result of the query yields a location of a mail server that accepts and handles email for the recipient's email address.

Conventionally, a person from India sending an email to a person from Dubai whose emails were hosted on a server in the US would waste bandwidth and time in retrieving emails. Bandwidth because an email meant for a recipient in Dubai would travel to the US and then back to the recipient in Dubai when the recipient requested for the email and time because the time required to retrieve and send an email from a server in the US to a recipient in Dubai would be slow compared to retrieving the email from a location closer to the recipient.

The process described in this invention tries to deliver the mail either directly to the recipient or to a storage server closest to the recipient. Initially, in order to authenticate both the sender and the recipient, when the sender and the recipient computing systems come online, the mail server proxy (MSP) and mail recipient proxy (MRP) authenticate the user against a lookup server. The lookup server can issue a limited duration digitally signed credential certificate that can be used by anyone to confirm the identity of a sender and recipient without having to contact the lookup server.

If the recipient's computing system has the MRP installed, the MRP can open an incoming socket on a port (ideally a common port such as 80/443 etc) and send the current public IP address and port of the recipient's MRP to a central recipient lookup server (LS) alongwith a security credential authenticating the recipient. The LS stores this information as recipient delivery parameters alongwith the recipient information. The MRP may also poll the. LS at frequent intervals to update this data incase the IP Address of the recipient changes, and to confirm to the LS that the recipient's internet connection is currently online. The LS maybe configured in such a fashion so as to treat a particular recipient's IP and port information as obsolete if it has not received a poll from the MRP for a predetermined period.

Additionally the invention describes a set of globally distributed mail storage servers (MSS) on which various recipients emails reside. It is also the goal of the present invention, to identify the mail storage server (MSS) closest to the recipient computing system. As per one embodiment, the mail recipient proxy (MRP) which resides on the recipient computing system identifies the MSS closest to the recipients computing system and designates such MSS as the storage location for the recipients email. In an alternate embodiment, the recipient mail client makes a standard request (POP3/IMAP etc) to download his email. The request is directed to the closest MSS using a standard geographical domain name service (DNS) resolution process as known in the art. The MSS is then designated by the MRP as the mail storage server for the recipient. Once the closest MSS for a recipient has been identified, the same is stored in the central lookup server (LS) against the recipient as part of the recipient delivery parameters. The LS as described previously can be a standard DNS server using simple TXT records or a custom protocol server configured to store the information described above

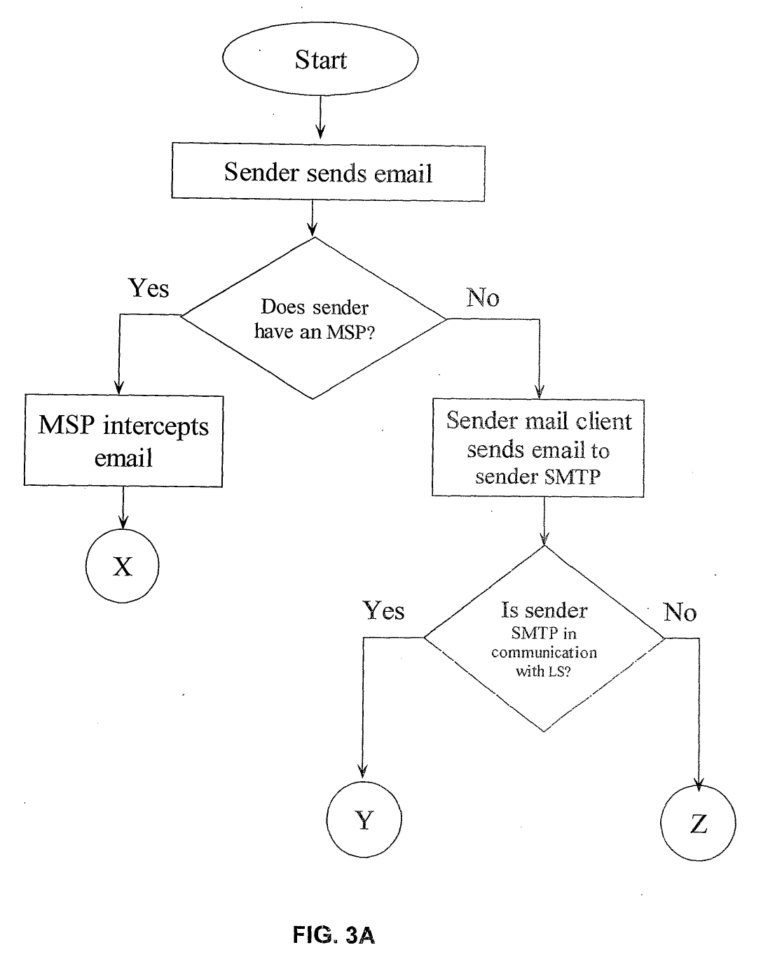

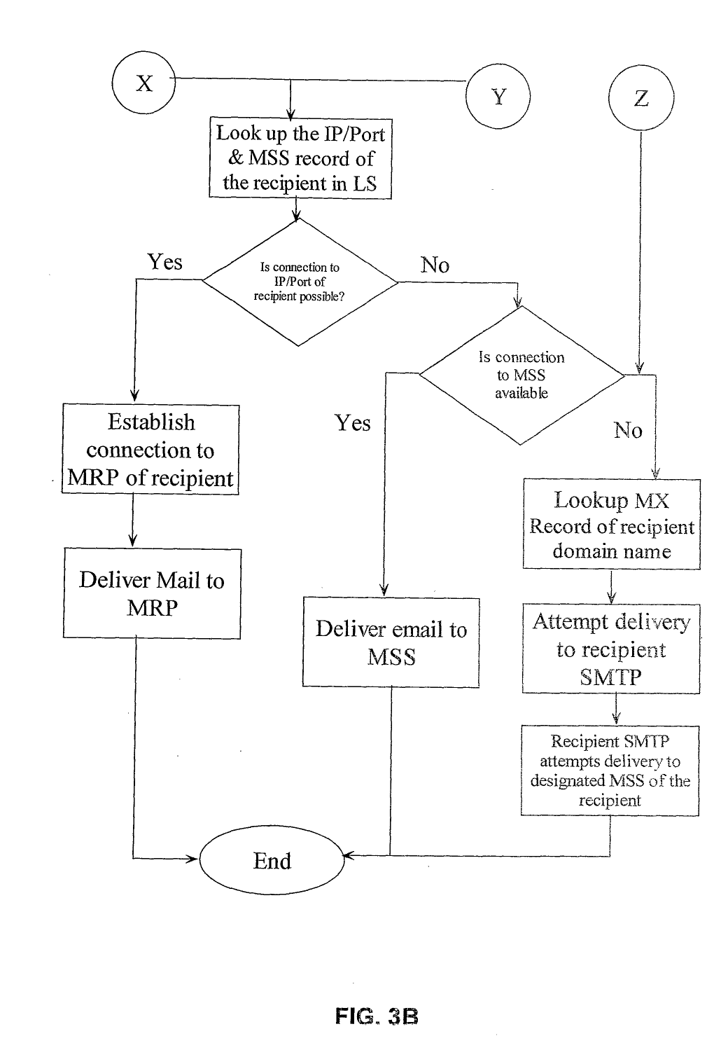

Referring now to FIG. 3A and FIG. 3B illustrates a flow diagram of a mail delivery process from a sender computing system to the recipient's computing system pursuant to an embodiment of the present invention. As per one embodiment, the sender drafts an email using an email client and sends the email to a recipient. An email comprises a local part, often the username of the recipient and the part after the @ sign is a domain name.

Now, if the sender computing system has an MSP installed, the MSP intercepts the email and contacts the lookup server (LS) for recipient delivery parameters pertaining to the recipient. The MSP sends sender delivery parameters and other credentials to the LS to authenticate itself. If the MSP is able to find a direct recipient IP and port record from the LS, the MSP makes a connection to the IP and port. The MRP at the recipients computing system is continuously listening for any incoming connections while the recipient is online and on receiving a request from the MSP it establishes a connection for incoming delivery of the email. The MRP accepts the email and stores it in the recipients mail client. The MSP can also mark the email as delivered and show a confirmation dialog to the sender that the delivery has been made to the recipient, and the mail is in the recipient's mail client. In one embodiment, the present invention can also provide the ability where the MRP can communicates with the MSP to confirm when the recipient actually read the email. In a situation, where the sender or recipient computing systems are behind a NAT/firewall, standard NAT UDP/TCP hole punching methods or other common network-oriented methods can be used to attempt email delivery through the NAT/firewall to the MRP. All communication between the MSP and MRP maybe encrypted. Prior to exchanging data between the MRP and MSP, they would exchange credentials to authenticate each other and ensure that the sender and recipient are indeed who they claim to be

Alternatively, if the recipients computing system is not online, or the MSP cannot successfully connect to the MRP or further if the recipient does not have an MRP installed, the MSP can locate recipients delivery parameters pertaining to the MSS associated with the recipient from the LS and directly attempt delivery of the email to the designated MSS. As per this embodiment, the recipient can download the email from the MSS as soon as the recipient comes online. Since the email will be stored at an MSS closest to the recipient, the time and bandwidth wasted to download the email from a server far away may be substantially reduced.

However, further if the MSP cannot even contact the MSS to deliver the email after obtaining the information from the LS, or alternatively if the MSP is not programmed to contact the MSS, the MSP simply forwards the email to the sender SMTP server to let it handle the delivery of the email. As per one embodiment, the MSP can cache the response received from the LS for certain duration to attempt to deliver subsequent emails without having to the email again if a connection can be established. In another embodiment, where the sender computing system does not have an MSP installed, the mail client at the sender computing system can send the email to the conventional sender SMTP Server and subsequently the sender SMTP Server follows the process of contacting the LS and attempting a delivery to the MRP or to the closest MSS associated with the recipient. If the sender SMTP Server is not programmed to contact the LS or it is unable to establish a connection to the LS or the MRP or the MSS, the sender SMTP server will send the email to the recipient SMTP Server and follow the regular process conventionally known in the art. The recipient SMTP Server will accept email for a recipient from the MSP or the Sender SMTP Server, and deliver the email to the designated MSS of the recipient. When the recipient computing system comes online, the MRP or the mail client can lookup the MSS and pull any email waiting at the MSS for the recipient. The location of the MSS being close to the recipient can ensure a fast delivery of the email to the recipient and a better email experience.

The embodiments presented above have several advantages that are highlighted below. However, those skilled in the art shall appreciate that the list of advantages are in no way exhaustive or meant to reduce the scope of the present invention. The advantages provided herewith a merely exemplary and the present invention shall be construed based on the full scope of the claims. Firstly, if the sender and the recipient comprise the MSP and MRP respectively and are both online at the same time, the email from the sender can be delivered to the recipient directly and immediately without passing through any DNS resolution process or the conventional SMTP and other intermediate servers. Further, if the recipient is not online, the sender's email is routed to an MSS closest to the recipient from where the recipient can download the email fast thereby reducing network bandwidth and time of delivery. Additionally, as stated previously, the present invention can cater to any form of communication application on a computing system with a change in the protocols and all such communication applications arc within the scope of the present invention.

What is claimed is:

1. A method of sending an electronic mail from a sender computing system to a recipient computing system, the method comprising:
updating a presence information of the recipient computing system and the sender computing system at a lookup server;
updating the recipient delivery parameters of the recipient computing system at a lookup server;
updating the sender delivery parameters of the sender computing system at a lookup server;
sending a request from the sender computing system to the lookup server to determine the presence information of a recipient computing system obtaining the recipient delivery parameters at the sender computing system from the lookup server; and
delivering the electronic mail directly to the recipient computing system based on the recipient delivery parameters.

2. The method of claim 1, further comprising:
delivering the electronic mail to a mail storage server if the sender computing system is unable to connect to the recipient computing system.

3. The method of claim 2, wherein the recipient computing system downloads the electronic mail from the mail storage server using at least one of a POP3, IMAP and a custom protocol.

4. The method of claim 2 wherein the mail storage server is the recipient's SMTP server.

5. The method of claim 2 further comprising:
forwarding the electronic mail to the sender SMTP server, for delivery, if the sender computing system is unable to connect to the mail storage server.

6. The method of claim 1, wherein the recipient delivery parameters comprise one of the public IP address and the NAT traversal information of the recipient computing system

7. The method of claim 1, wherein the sender delivery parameters comprise one of the public IP address and the NAT traversal information of the sender computing system

8. The method of claim 1, further comprising:
obtaining the sender delivery parameters from at least one of the lookup server and the sender computing system by the recipient computing system; and
sending a confirmation of receipt of the electronic mail directly to the sender computing system.

9. The method of claim 8, wherein the recipient computing system caches the sender delivery parameters

10. The method of claim 1, wherein the sender computing system caches the recipient delivery parameters.

11. The method of claim 1, wherein the sender computing system is a SMTP server of a sender.

12. The method of claim 1, wherein the sender computing system and the recipient computing system use digital certificates to confirm identities of the sender computing system and the recipient computing system.

13. The method of claim 1, wherein the presence information, the recipient delivery parameters, and the sender delivery parameters are updated periodically at the lookup server.

14. The method of claim 1, wherein the sender computing system and recipient computing system use Interactive Connectivity Establishment (ICE) to exchange data when at least one of the recipient computing system and the sender computing system is behind at least one of a NAT and firewall.

15. The method of claim 1, wherein all communication between the sender computing system and the recipient computing system is encrypted.

16. The method of claim 1, wherein the lookup server is a DNS server.

17. The method of claim 1, wherein the lookup server stores the recipient delivery parameters and the sender delivery parameters using at least one of a text (TXT) records and service (SRV) records.

18. A system for delivering an electronic mail to a recipient computing system, the system comprising:
a mail sender proxy for updating a presence information and a sender delivery parameters of the sender computing system at a lookup server;
a mail recipient proxy for updating a presence information and a recipient delivery parameters of the recipient computing system at a lookup server;
a lookup server for sending the presence information of the recipient computing system and the recipient delivery parameters to the mail sender proxy and sending the presence information of the sender computing system and the sender delivery parameters to the mail recipient proxy; and
a sender computing system to deliver the electronic mail to the recipient computing system based on the recipient delivery parameters.

19. The system of claim 18, wherein the mail sender proxy can be a part of at least one of a sender SMTP server, a sender computing system and an internet service provider server.

20. The system of claim 18, further comprising a mail storage server, to which the sender computing system delivers the email, if the sender computing system is unable to connect to the recipient computing system.

21. The system of claim 20 wherein the mail storage server is the recipient's SMTP server.

22. The system of claim 20, further comprising a sender SMTP server to which the sender computing system forwards the electronic mail if the sender computing system is unable to connect to the mail storage server.

23. The system of claim 18, wherein the recipient delivery parameters comprise one of the public IP address and the NAT traversal information of the recipient computing system

24. The system of claim 18, wherein the sender delivery parameters comprise one of the public IP address and the NAT traversal information of the sender computing system

25. The system of claim 18, wherein the recipient computing system obtains the sender delivery parameters from at least one of the lookup server and the sender computing system and sends a confirmation of receipt of the electronic mail directly to the sender computing system.

26. The system of claim 25, wherein the sender computing system caches the recipient delivery parameters and the recipient computing system caches the sender delivery parameters.

27. The system of claim 18, wherein the sender computing system is a SMTP server of a sender.

28. The system of claim 18, wherein the sender computing system and the recipient computing system use digital certificates to confirm identities of the sender computing system and the recipient computing system.

29. The system of claim 18, wherein the presence information, the recipient delivery parameters, and the sender delivery parameters are updated periodically at the lookup server.

30. The system of claim 18, wherein the sender computing system and recipient computing system use Interactive Connectivity Establishment (ICE) to exchange data when at least one of the recipient computing system and the sender computing system is behind at least one of a NAT and firewall.

31. The system of claim 18, wherein all communication between the sender computing system and the recipient computing system is encrypted.

32. The system of claim 18, wherein the lookup server is a DNS server.

33. The system of claim 18, wherein the lookup server stores the recipient delivery parameters and the sender delivery parameters using at least one of a text (TXT) records and service (SRV) records.
